(19) United States
(12) Patent Application Publication
(10) Pub. No.: US 2004/0215428 A1
(43) Pub. Date: Oct. 28, 2004

(54) Method for producing property-preserving variable resolution models of surfaces

(75) Inventors: Rafael L. Bras, Lexington, MA (US); Dara Entekhabi, Cambridge, MA (US); Enrique R. Vivoni, Cambridge, MA (US); Valeri Y. Ivanov, Cambridge, MA (US)

Correspondence Address: Randy J. Pritzker, Wolf, Greenfield & Sacks, P.C., 600 Atlantic Avenue, Boston, MA, 02210, US

(73) Assignee: Massachusetts Institute of Technology, Cambridge, MA (US)

(21) Appl. No.: 10/458,612

(22) Filed: Jun. 10, 2003

Related U.S. Application Data
(60) Provisional application No. 60/465,931, filed on Apr. 28, 2003.

(51) Int. Cl. G06F 17/10

(52) U.S. Cl. 703/2

(57) ABSTRACT

A computer-implemented method of generating, with respect to a surface, a model-specific, computationally efficient representation of a data set pertaining to a property of the surface. In one embodiment, the data set is mapped with an index function to create mapped data points; the mapped data points are grouped based on a value of the index function for each of the mapped data points; using a selection function, mapped points are selected, for each group, for inclusion in a final representation; and a final representation of the data set is generated using, for each mapped point in each group which is selected for inclusion, a corresponding original data point. The method is capable of generating a variable resolution model by using a physics-based or model-specific index function to indicate the impact of data on a model. The method may be used to generate TIN models used in areas such as hydrology or geomorphology

### RELATED APPLICATION

This application claims the benefit under 35 U.S.C. § 119(e) of U.S. Provisional Application No. 60/465,931 filed Apr. 28, 2003, entitled “METHOD FOR PRODUCING PROPERTY-PRESERVING VARIABLE RESOLUTION MODELS OF SURFACES,” by Rafael L. Bras, et al.(Attorney's Docket Number M00635.70080). The entirety of the aforementioned application is hereby incorporated by reference.

### FIELD OF THE INVENTION

This invention relates to the field of modeling properties of surfaces, for diverse applications such as, but not limited to, modeling hydrological and geomorphic properties of the earth's surface and other applications using finite element mesh surface models.

### BACKGROUND

In various fields, such as hydrology and geomorphology, studies of the properties of a surface, such as its response to rainfall, require representational models which efficiently describe surface elevation and relate appropriate factors to the elevation contour. The representational models are often incorporated into geographical information systems (GIS) which are used to analyze and make predictions about various surface factors. One type of model for such surface studies is referred as a finite element mesh (FEM).

Finite element mesh (FEM) models are used in a number of fields and in a variety of ways. Examples of such uses include data models where data is mapped as a function of x-y (or x-y-z) coordinates in a (two- or three-dimensional) grid, such as in cartography, geology, hydrology, mineralogy, and meteorology, and also applications such as structural mechanics, engineering design, and fluid mechanics. In earth sciences, these applications are useful for predicting floods, landslides, river dynamics, or erosion, as well as for geological surveying and prospecting for oil or mineral deposits. For example, in hydrology, the data may be high-resolution topographic data obtained from land surveying, aerial photography, or synthetic aperture radar. Indeed, FEM models have uses in almost every scientific and engineering field, or in any field where multidimensional data is used for analysis or modeling.

Many examples of FEM models exist. The most straightforward method of forming a FEM model is simply to represent the surface or structure being modeled with a grid or matrix of data points in two or three dimensions. The value at any coordinate in the grid or matrix represents a value of the property to represented for a corresponding point on or in the system, device, or apparatus to be modeled. For example, in the case of a digital elevation model, the value at a designated point in a two-dimensional grid might represent the elevation at a corresponding location in an area of the Earth's surface to be modeled. In another example, the value at any point in a two-dimensional grid may represent an emission or absorption coefficient for electromagnetic waves of a specific frequency in a material or area to be modeled, to determine information about stress, structural defects, or the composition of the material or area. The resolution of the FEM model is determined by the spacing and number of points in the FEM, which ideally reflects the resolution of the data to be used. However, for many applications this method proves unwieldy in both the storage space and computational time required when performing operations on the data set. For example, FIG. 1 shows a digital elevation map data representation of the Mississippi River basin 101, which covers an area of approximately 3,196,675 square kilometers, obtained from the North American HYDRO1K database at a resolution of 1 kilometer. A digital elevation map (DEM) represents an area on a surface with a grid of points wherein the value of each DEM point represents the elevation of a corresponding location on the land area being studied The DEM model of FIG. 1 contains approximately 3,200,000 elevation points. Likewise, smaller regions having higher resolution data present the same problem. Thus, for many applications which require rapid or real-time predictive power, the large amounts of data associated with such a simple and direct method of forming FEM models are computationally infeasible or expensive. Conventionally, high-resolution grids require some manner of data reduction to obtain reasonable computational performance. Typically, for DEMs, such a reduction is achieved through pixel aggregation at the expense of resolution. Such tradeoffs are necessary, as it has been shown in some cases that a linear reduction in the grid cell size of a model results in an exponential increase in computational time for certain models. Additionally, this raster method of representing data is not well suited to data which is not acquired in a uniform manner. For instance, in geophysical applications, data is often obtained by scanning in raster-like lines, where the resolution along a line is four to five times higher than the resolution across lines. Using previously known techniques such as minimum curvature gridding, adjustments may be made for the inconsistency in resolution, but such techniques also result in the loss of resolution along the scan lines. For many geophysical, hydrological, and meteorological applications, such a loss of resolution due to data aggregation and raster effects is an important source of error when modeling. Such representation problems grow with the spatial scale of the data and the models which are based on them.

Another group of FEMs, which offer an advantage over raster grids, are Triangular Irregular Networks (TINs). TINs are FEMs in which regularly or irregularly spaced points are used to construct an array of adjacent, non-overlapping triangles.

Many techniques are known in the art for constructing a TIN mesh from grid data. For instance, one method of forming TINs, known as Delaunay triangulation, which results in a nearly unique and optimal triangulation, ensures that a circle passing through three points on any triangle contains no additional points. In the prior art, essential topographic information is preserved by selectively sampling elevation points in a DEM for inclusion in a TIN based on some criteria. Various methods exist for selecting critical points from dense DEMs. Two such methods include the very important point (VIP) and the drop heuristic (DH) methods. The VIP method is a local procedure that determines the significance of a point relative to a 3×3 filter of points by comparing the actual elevation at that point to the elevation interpolated from the four transects of the 3×3 filter. In the VIP method, a percentage is specified which determines the ratio of the number of remaining nodes in the TIN to the number of original points in the DEM. The DH method is a global procedure that successively removes DEM points while maintaining the surface of the resulting TIN within an elevation tolerance of the original data, where the elevation tolerance is specified and determines the number of remaining nodes. FIG. 2 shows an USGS 30 meter resolution DEM representing an area within Peacheater Creek Basin, Okla. FIG. 3 shows a TIN of the same area within the Peacheater Creek Basin generated using the VIP method of selecting points (with 16% of points retained). FIG. 4 shows another TIN of the same area generated using the DH method (with a specified elevation tolerance of 8 meters). Typically, the DH approach exhibits lower root mean square errors, and thus is used in embodiments of the invention. However, it will be understood by those skilled in the art that the VIP method or any other suitable selection method may be used in the present invention.

Whereas typical grid representations are bound to a single resolution, TIN models are inherently multi-resolution, and are capable of resolving finer regions and abrupt changes. The resulting TINs normally have higher resolution in rugged areas, where elevation is more variable, and lower resolution in flat areas. Thus, to some extent, TINs can reduce the number of computational nodes required in a model, while still preserving the properties of the model. However, the predictive power of a TIN based model still suffers from memory and computational constraints imposed by large amounts of data. Thus, TINs are well suited to handling irregularly spaced data, but the constraints of memory space and computational speed still often require the sacrifice of some data. Conventionally, this sacrifice in resolution still introduces error into computational models.

What is needed is a method of efficiently constraining the data representation used in models for applications such as hydrology which substantially preserves the information needed to make accurate analysis and predictions.

### SUMMARY OF THE INVENTION

According to one aspect of the invention, a computer-implemented method of generating a model-specific, computationally efficient representation of a data set comprising an array of original data points comprises: mapping the data set with an index function to create mapped data points; grouping the mapped data points into groups based on a value of the index function for each of the mapped data points; using a selection function, selecting, for each group, mapped points for inclusion in a final representation; and generating a final representation of the data set using, for each mapped point in each group which is selected for inclusion, a corresponding original data point.

According to another aspect of the invention, a computer-implemented method of generating a finite-element mesh incorporating model-specific response to produce variable resolution in the mesh comprises: assigning an index value to each of a group of original elements based on an index function providing a heuristic measure of impact on a model to produce an indexed element for each original element; grouping the indexed elements into at least two groups based on the index value of each element; selecting a subset of indexed elements from each of the groups based on a selection function; creating a finite-element mesh for each of the groups using the corresponding original elements of each of the subset of indexed elements selected by the selection function; and combining the finite-element mesh from each of the groups into a final finite-element mesh.

According to yet another aspect of the invention, a computer-implemented method of processing an original data set using variable resolution filters, the method comprising: using a ranking function, generating a ranked data set from the original data set; binning a plurality of ranked data points from the ranked data set into at least one bin based on a ranking value of each of the ranked data points; selecting a group of ranked points from each at least one bin according to a selection function based on a rank value of each of the ranked points; creating a data structure for each at least one bin by selecting, for each ranked point from the group of ranked points selected from that bin, a corresponding point from the original data set; and incorporating the data structure from each at least one bin into a final data structure.

According to yet another aspect of the invention, a computer-implemented method for generating a physically constrained finite-element terrain representation comprises: measuring a set of terrain characteristics for a group of points inside a land area using available digital elevation data; storing the set of terrain characteristics for the group of points in a computer readable medium; using an index function which is a function of the set of terrain characteristics, assigning to each point of the group of points an index value; binning the points into at least two bins based on the index value of each point; using a selection function, selecting a set of points from each of at least two of the bins; generating a finite-element mesh using each selected set of points; and storing the finite-element mesh in a computer memory.

### BRIEF DESCRIPTION OF THE FIGURES

FIG. 1 is a DEM of the continental-scale Mississippi River basin depicting an 3,196,675 square kilometer area, at a resolution of 1 km, obtained from the HYDRO1K database.

FIG. 2 is a 30-meter resolution DEM of an area in the Peacheater Creek basin in Oklahoma, obtained from the USGS (United States Geographical Survey).

FIG. 3 is a TIN of the DEM shown in FIG. 2 generated using the VIP method.

FIG. 4 is a TIN of the DEM shown in FIG. 2 generated using the DH method.

FIG. 5 is a flow chart illustrating a method according to the present invention.

FIG. 6 is a map of the spatial distribution of the saturation runoff index of the Baron Fork Watershed from a 30-meter USGS DEM.

FIG. 7 is a graph of the probability distribution of the runoff index values for the region shown in FIG. 6.

FIG. 8 is a map of the spatial distribution of an erosion index of the Owl Creek basin from a 30-meter USGS DEM.

FIG. 9 is a graph of the probability distribution of the erosion index values for the region shown in FIG. 8.

FIG. 10 is a map of the spatial distribution of the shallow landslide index of the Tolt River basin from a 26-meter SRTM (Shuttle Radar Topography Mission) DEM.

FIG. 11 is a graph of the probability distribution of the shallow landslide index values for the region shown in FIG. 10.

FIG. 12 is a graph of a functional relationship between the mean separation d_{c} of a group of points and the index value of those points.

FIG. 13 is another graph of a functional relationship between d_{c} and index value.

FIG. 14 is another graph of a functional relationship between d_{c} and index value.

FIG. 15 is an example of a TIN generated according to the present invention.

FIG. 16 is a portion of a hydrologically constrained TIN of the Mississippi River Basin depicting area 102 of FIG. 1.

FIG. 17 is a comparison of the elevation frequency PDFs for the Mississippi River basin using the HYDRO1K DEM (1 km resolution) shown in FIG. 1, the hydrologic similarity TIN model of FIG. 16, and a DEM aggregation (5.65 km resolution) having a comparable data reduction factor.

FIG. 18 is a comparison of the topographic index frequency PDFs for the Mississippi River basin using the HYDRO1K DEM (1 km resolution) shown in FIG. 1, the hydrologic similarity TIN model of FIG. 16, and a DEM aggregation (5.65 km resolution) having a comparable data reduction factor.

### DETAILED DESCRIPTION

For ease of discussion and exposition in this application, the field of hydrology will be used to provide a demonstrative example of one application of the invention, and various aspects and embodiments of the invention will be discussed in this context. However, as discussed, the present invention may be applied in any field in which finite element modeling and/or TINs, in particular, are used, and where the computational efficiency and predictive power of models are considerations.

As stated, it is frequently useful in hydrology to use topographical or surface data to study or attempt to predict the hydrological characteristics of an area, such as saturation characteristics, erosion patterns, landslide hazards, etc. This data is usually supplied in the form of raster data or a DEM. This data could be obtained from satellite measurements, measurements made aboard the space shuttle or International Space Station, airborne measurements, ground measurements such as surveys, etc. The measurements could be made with any of various forms of radar. For instance, the measurements might be made using synthetic aperture radar. The measurements might also be made using laser positioning, GPS data, sonar, or any other suitable method. The data can be recorded, stored, and analyzed in the same system which takes the measurement; conversely, each stage in the process of measuring, recording, and analyzing the data points may occur in a different system, with data transfers taking place between each step. For example, measurements may be done using airborne synthetic aperture radar and transferred via a digital or analog communications channel to a separate computer system for analysis. In another example, the measurements may be performed on the ground by multiple agents, and the measurements may be transmitted via a communication channel for assembly and analysis.

Once this DEM data has been obtained, it may be analyzed by the same device that took the measurements, or, more typically, be transferred to one or more other computers for analysis. Such computers may include, for example, main frame computers, personal computers, distributed computing networks, embedded processing devices, laptops, handheld computers, PDAs, and other computing devices. One skilled in the art will appreciate that any of the foregoing or a variety of other methods of obtaining and analyzing data are suitable for use of with the present invention.

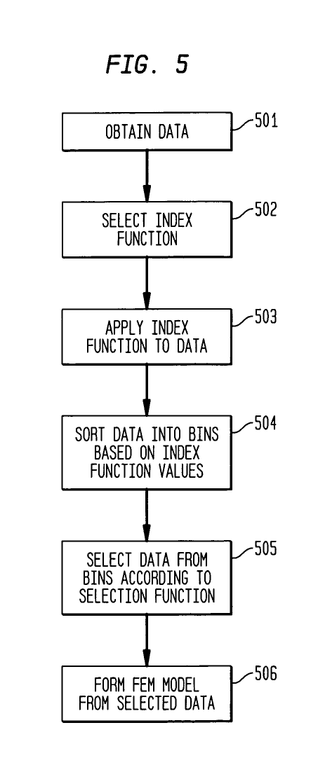

FIG. 5 illustrates graphically, using a flow chart, the general process of producing a hydrologically-constrained triangular irregular network.

After obtaining the DEM points through measurement and transferring them to the system on which analysis will take place (act 501, which is outside the scope of the invention), each point is mapped to a corresponding index value based on a particular “index function”. In this context, the index function may be a topographic distribution function. As shown in act 502, after obtaining the data to be analyzed (act 501), an index function is chosen. The index function is a function of the properties of a point and/or the properties of neighboring points and in general is based on the physics involved in a particular process being modeled. The value of an index function at a point describes the characteristics or properties of that point with respect to a particular model. These characteristics or properties may, for example, describe a response to a stimulus, whether it be an impulse or steady state response. For example, in the field of hydrology, topographic distribution functions have been used to classify local hydrologic similarity. Preferably, the value of an index function at a point is related to the significance of that point in a particular model, that is, the probability of the data point affecting the behavior of a given model; thus, index functions are preferably selected based on their ability to predict the impact of the data from a point or group of points on the predictive accuracy or behavior of the resulting model. The index function used will depend on the type of model being produced. For a given dynamic property or group of properties in a system that is to be modeled, one or more corresponding index functions may be selected. These functions may be empirical or derived from properties of a given process or system being modeled. There may exist a library of such index functions on the computer system performing the analysis and generation of the constrained FEM. It may be desirable to assign multiple index values to each data point based on different index functions. These multiple index values may be combined with an adjustable parameter so that a particular model may make use of a combination of different response characteristics in order to tune it for a particular application.

For instance, in generating a hydrologically constrained TIN model, if the saturation characteristics of a given area are to be modeled, a wetness index may used as the index function. Alternatively, if the process to be modeled is land-surface evolution or sediment transport, an index function related to erosion potential would be appropriate. The choice of index function depends on the modeling objective.

In addition, index functions may be time variable. For instance, in a model of erosion or landslide response the index functions or surface properties of certain points may be periodically updated to reflect changes predicted by the model. In the case of landslide modeling, an area which is predicted to landslide will be updated to reflect the fact that physical characteristics have been altered and the updated index function will reflect the fact that subsequent landslides are less likely.

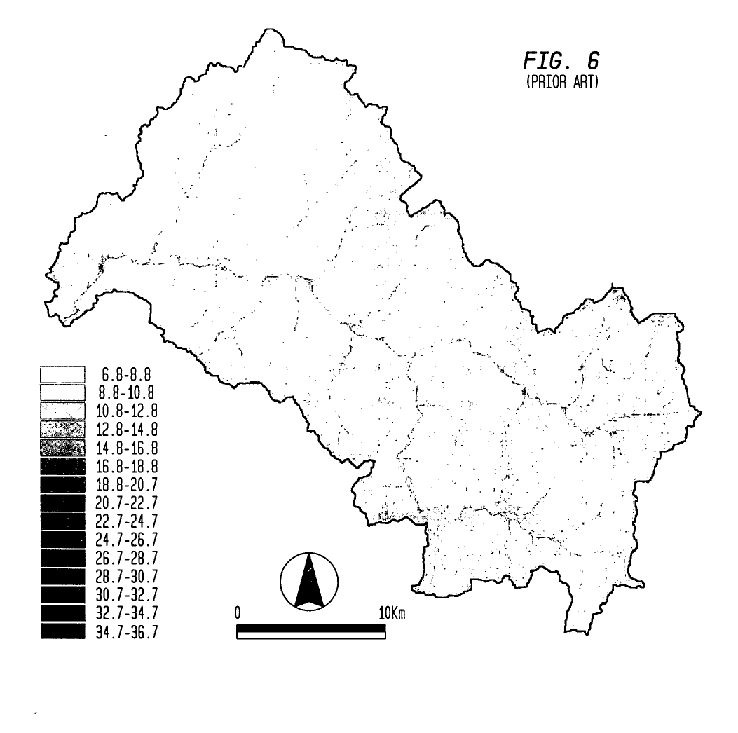

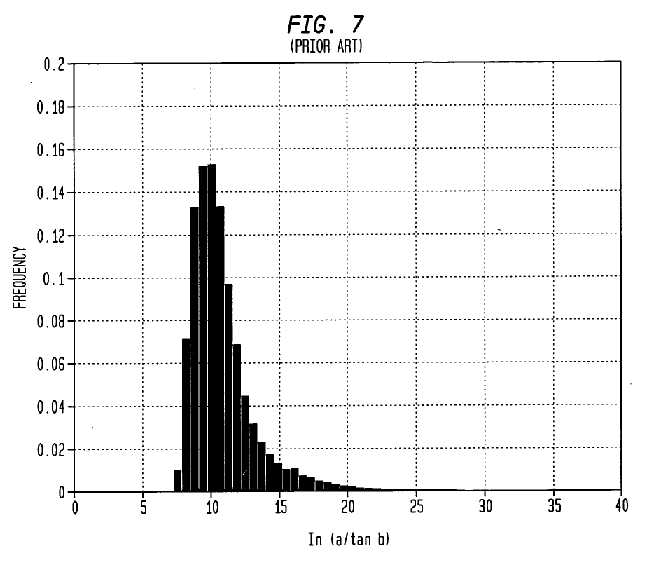

One example of an index function useful in generating hydrologically constrained models is the measure of saturation excess runoff, typically represented as λᵢ,=ln(αᵢ/tan βᵢ) where λᵢ is the index function value for the ith grid or point in a DEM, αᵢ is the pixel contributing area per unit width (i.e., the area that contributes to the flow at a point) and tan βᵢ is the local pixel slope. Thus, index function value λᵢ is calculated by taking the natural logarithm of the amount of drainage or flow through an original element or a surrogate thereof, such as drainage area associated with an original element, divided by the slope associated with that element. This index distinguishes between areas that saturate frequently (and which have a large λᵢ value) and hillslope regions lacking runoff production (which have a small λᵢ value). An example of the application of the hydrologic wetness index function as applied to a DEM is shown in FIG. 6, which shows a map of the value of the index function of the Baron Fork Watershed. FIG. 7 shows a frequency distribution of the index values for the region.

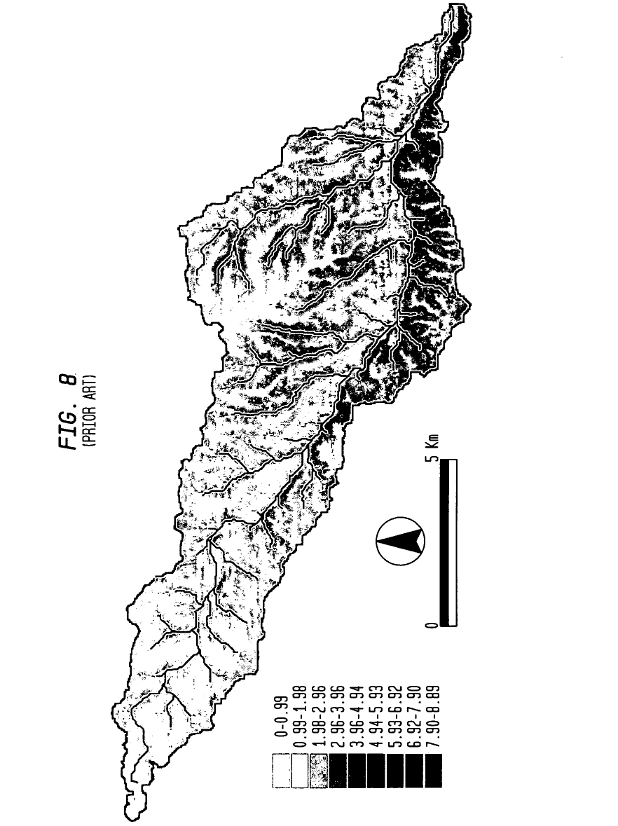

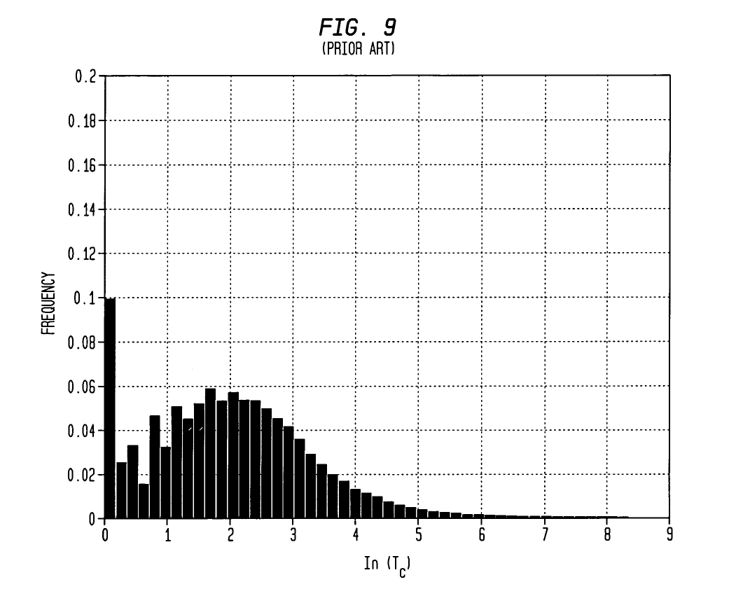

Another example of an index function, used in characterizing landscape geomorphology, is a measure of the transport-limited sediment erosion, given by

$${T}_{c} ≡ {( \frac{a}{22.13} )}^{m} {( \frac{sin β}{0.0896} )}^{n}$$

where T_{c} is a dimensionless transport index, m=0.56 or 0.9, n=1.22 or 1.05 for rill and sheet erosion erosion, respectively. This index describes net erosion, and catchment areas with similar T_{c} calues are considered to have equal erosion potential under equilibrium conditions. Because the value of T_{c} may vary widely in mid-to-large basins, the log transform of T_{c} may also be used as an index function. An example of the application of the sediment transport index function as applied to a DEM is shown in FIG. 8, which shows a map of the value of the index function of the Owl Creek Watershed. FIG. 9 shows a frequency distribution of the erosion index values for the region. In FIG. 9, the logarithm of T_{c} is used.

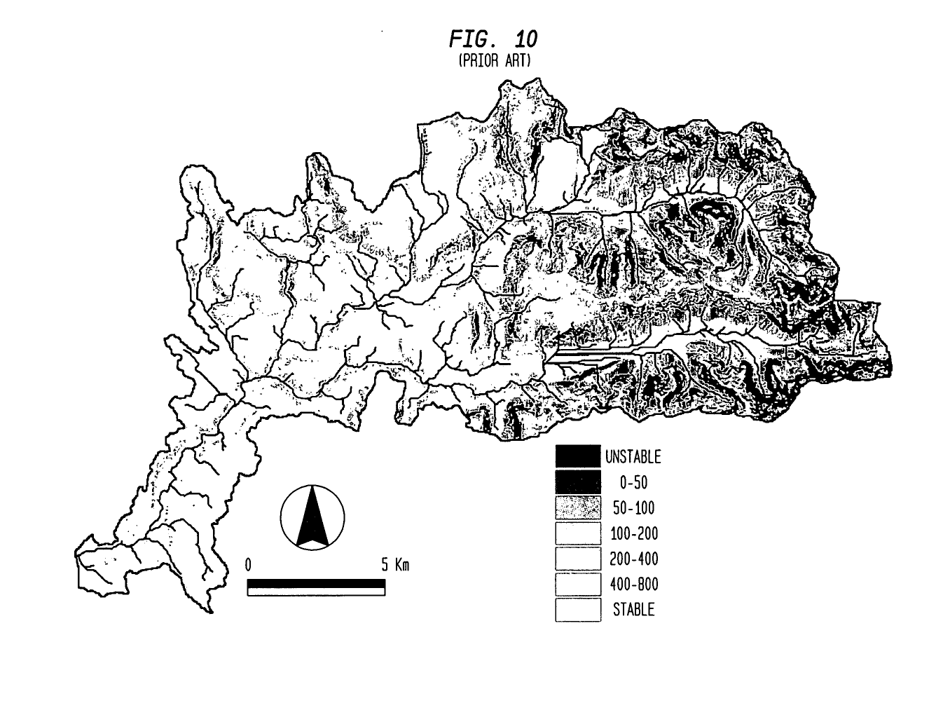

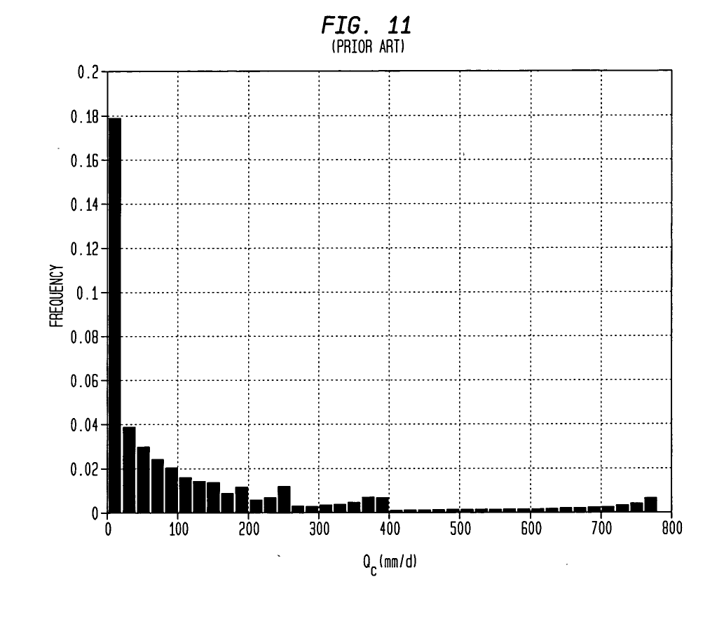

Yet another example of a useful index function is a measure of the critical steady-state rainfall (Q_{c}) required to trigger shallow landslides, and (for cohesionless soil) is expressed as:

$${Q}_{c} = \frac{T sin β}{a} [ \frac{{ρ}_{s}}{{ρ}_{w}} ( 1 - \frac{tan β}{tan φ} ) ] ,$$

where T is saturated transmissivity, ρₛ is the soil bulk density, p_{w} is density of water and φ is the soil friction angle. The critical rainfall predicted to cause instability can be used as a measure of landslide hazard. Given a steady rainfall rate, similarity in landscape response to Q_{c} classifies element with equal (landslide initiation potential given a steady rainfall rate. An example of the application of the shallow landslide index function as applied to a DEM is shown in FIG. 10, which shows a map of the value of the index function of the Tolt River Watershed. FIG. 11 shows a frequency distribution of the index values for the region.

Other index functions, appropriate to the particular application, will be apparent to those skilled in the art of finite element modeling and will be specific to the nature of the model being studied.

As shown in act 503 of FIG. 5, once an appropriate index function (e.g., topographic distribution function) has been selected, an index value is mapped to each of the points in the DEM.

Once index values have been calculated for each data point, the points are grouped (act 504) based on their respective index values. In the illustrated embodiment, the DEM data points are first sorted into groups and placed in “bins” in memory based on their respective index values, in a predetermined way. For instance, the K data points may be ordered according to their index values and separated into N bins, each bin containing K/N data points, where the first bin contains the K/N data points with the lowest index values, the second bin contains the next highest K/N data points, etc. Alternatively, the ranges which are used to separate the data points into bins may be predefined by ranges of possible index values, wherein the points assigned to the bins based on their index values. The N bins may be defined by ranges of index values, wherein each bin has a predetermined index value range and all points falling within that range are assigned to the corresponding bin. For instance, a maximum range for a data set may be defined by a theoretical maximum and minimum for a given index function, or alternatively by the maximum and minimum index values in a given data set. The maximum range may then be divided into N equally sized index ranges, each one defining a respective bin range. It will be understood that these groups or bins may not correspond physically to a particular area of memory in the computer system on which the analysis is performed; they may, for example, correspond to areas of virtual memory in a computer or particular piece of software.

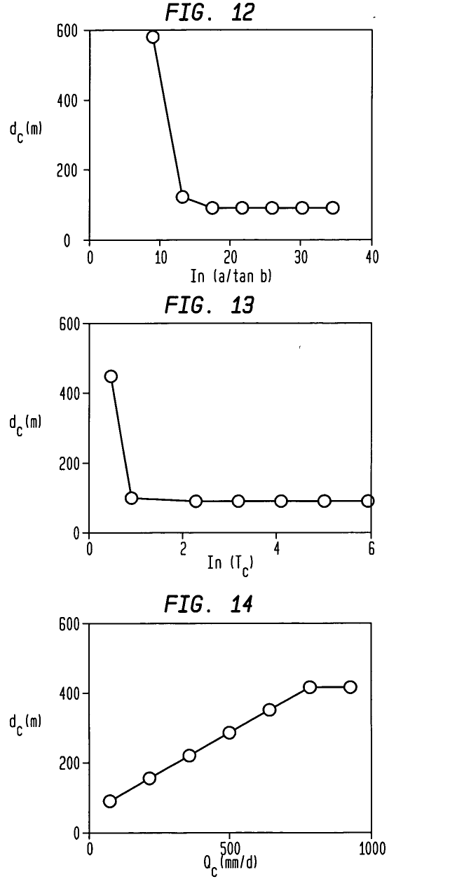

After the points have been sorted into bins, data points are selected from the bins in act 505 for inclusion in the FEM. The points are selected as a function of the characteristic index value of their respective bin or group, which may be, for instance, the mean index value of the bin. A variety of selection functions may be used. The rate or manner in which the data points are sampled is made dependent on the value of the index function; preferably, points which are more likely to influence the dynamics of the model (based on the value of their index function) are sampled at a rate that makes them more likely to be selected for inclusion in the model. In one example, each bin or group may have an associated probability of selection associated with it, which would preferably be higher for bins with higher mean index values. (For ease of discussion, it will be assumed henceforth that index values are positively correlated with impact on the model or simulation being developed, but it will be understood that a particular index might produce lower values for points having a greater influence on the model.) In this way the selection function may have probabilistic aspects. In another example, a number of data points with the highest index values in each bin may be selected for inclusion in the model. However, preferably, to objectively select DEM points, a functional relationship is established between the mean index value of each bin and the mean distance between points in that bin. The mean distance proximity is used as a criterion to filter the points in the DEM. By limiting the mean distance between points in a particular bin, the number of points chosen from that particular bin as well as their relative distribution in a FEM can be controlled. FIGS. 12-14 show three examples of functional relationships between index value and the mean distance between points. FIG. 12 shows the relationship between the mean point spacing d_{c} (given in meters) and the hydrologic wetness index value for a group of points in a particular model. As can be seen, in this case, points having a lower wetness index value were chosen at a lower rate for inclusion in the TIN, as demonstrated by the higher mean distance between those points. FIG. 12 demonstrates a functional relationship for a TIN based on a sediment transport function. Similar to FIG. 12, FIG. 13 shows that the density of points having low sediment transport index values is low, as demonstrated by their high mean separation. FIG. 14, on the other hand, shows a graph of the mean distance between points for a model based on the shallow landslide index wherein points having a lower value of the shallow landslide index are more likely to be included in the model, as demonstrated by their low mean separation (high density). In this case, points having a low index value were more likely to impact the accuracy or effectiveness of the particular model. Other relationships are possible, depending on the particular application. In some cases, the form of this relationship may be linear. A maximum and minimum possible mean index value may be defined, and the difference between them divided by the number of bins to yield an incrementing value, δ. The bin having the greatest impact on the model is assigned the smallest mean distance value. This allows for the greatest possible selection of points from that bin, since, according to their mean index value, those points are more likely to affect the model. Points from the bin having the next highest mean index value are selected to allow a mean distance which is higher by the incremental amount δ, until finally the bin with the least important mean index value is assigned the maximum possible mean distance. The range of possible mean distances may depend both on the physical limitations of the data being analyzed and on the limitations of the system being modeled or dynamics processes in that model. For instance, in many applications, the smallest possible mean distance which could be achieved between the selected points of a bin is limited by the resolution of the original data, since it is a lower limit on the spacing between data points. For example, in hydrology, the maximum mean distance between points in a bin is limited by the mean hillslope length of the land area being modeled or properties thereof. The mean hillslope length is defined by catchment area (A) divided by two times the total stream length (L_{T}). The mean hillslope length is related to the average distance from any location to a stream. One particular advantage of the using the previously described functional relationship in hydrologic applications is that no parameter must be specified, since the minimum and maximum mean distance are readily calculable from the data present.

It will be recognized by those skilled in the art that functional relationships other than those discussed above are also possible. For example, the relationship between mean index value and mean distance between points chosen form a bin may be exponential. In addition, as discussed above, the functional relationship may relate the mean index of a bin with some other criterion for selection. For example, it may relate to a probability of selection for points within a given bin.

It is possible to adjust the resolution of the resulting model and the extent to which the desired behavior-producing characteristics of the original data are preserved in the final model by modifying the bin parameters and the selection function. For example, if the DEM data points were sorted into a single bin regardless of their index values, and selected with a uniform probability within that bin, the TIN model constructed from the resulting selected DEM points would have no advantage in preserving the desired properties of the system over previously known methods of constructing TIN models.

While the selection process discussed above preferably includes sorting the data points into bins, sorting is not required. For instance, the selection function may operate on data points and simply use a probabilistic function where the probability of selecting a point for inclusion in the model depends on its index value. In this manner, selection may be accomplished in one act.

After points from the various bins are selected according to their index values for inclusion in the FEM, a FEM is constructed out of the selected points, as shown in 506 of FIG. 5. It is important to note that the resulting FEM, which is preferably a TIN, is constructed using the original data values of the selected data points, not the index values of the selected points. Thus, for example, a hydrologic TIN resulting from analysis of a topographic DEM still describes the elevation of the selected points, but the points have been selected according to a heuristic function in order to predict their impact on the accuracy of a particular hydrologic model or simulation.

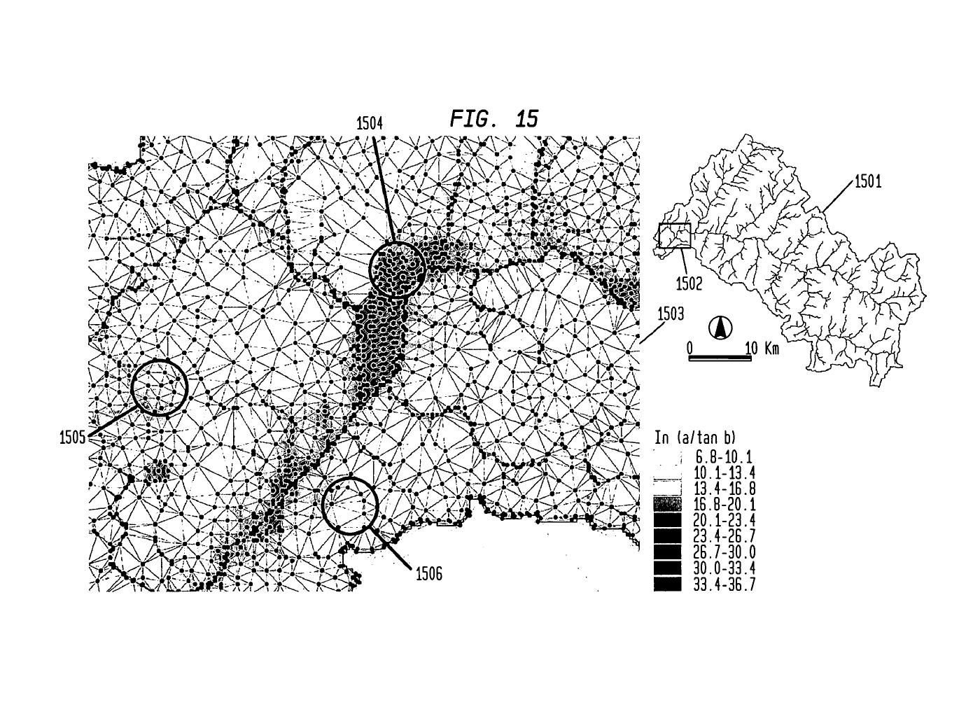

FIG. 15 shows one example of a hydrologically constrained TIN generated according to the present invention. 1501 shows a map of the Baron Fork Watershed. 1503 shows a process-constrained TIN of area 1502 generated according to the present invention. Regions 1504-1506 indicate areas having different mean separations between points based on the index values of the points, where the mean separation varies from 90 to 200 meters. Region 1504 shows an area in which the mean separation is 90 meters. Region 1505 shows an area in which the mean separation is 120 meters. Region 1506 shows an area in which the mean separation is 200 meters.

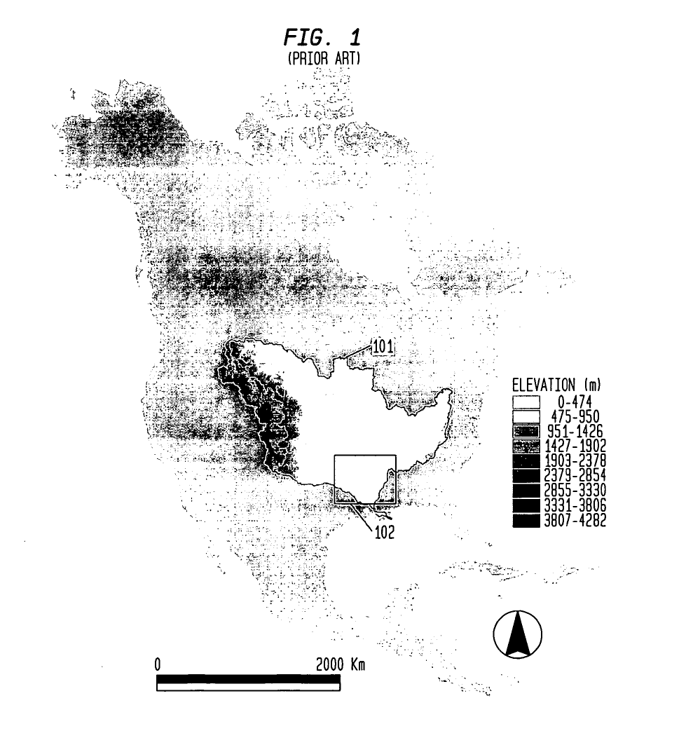

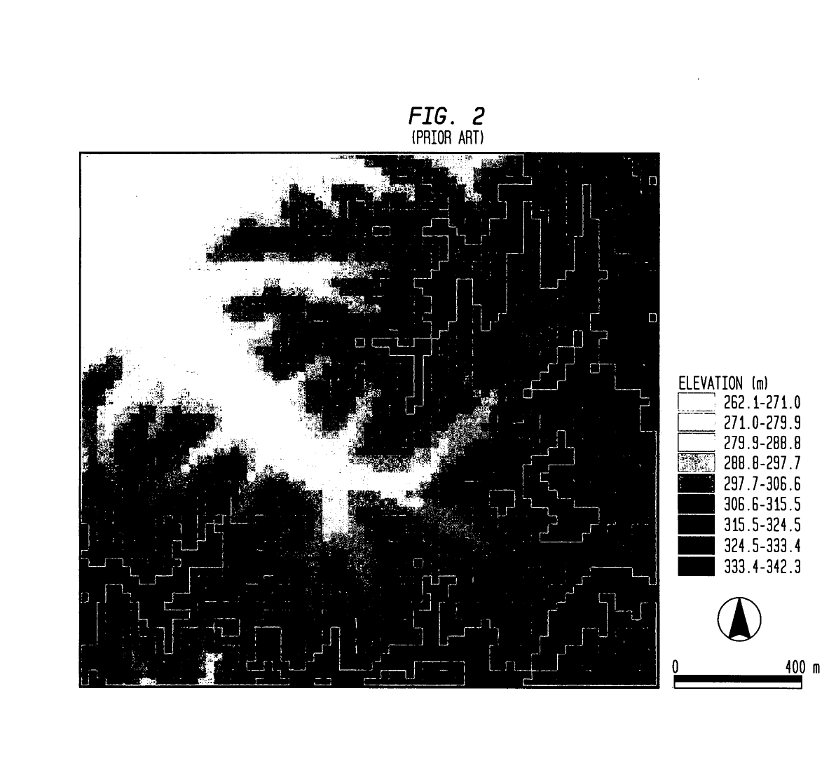

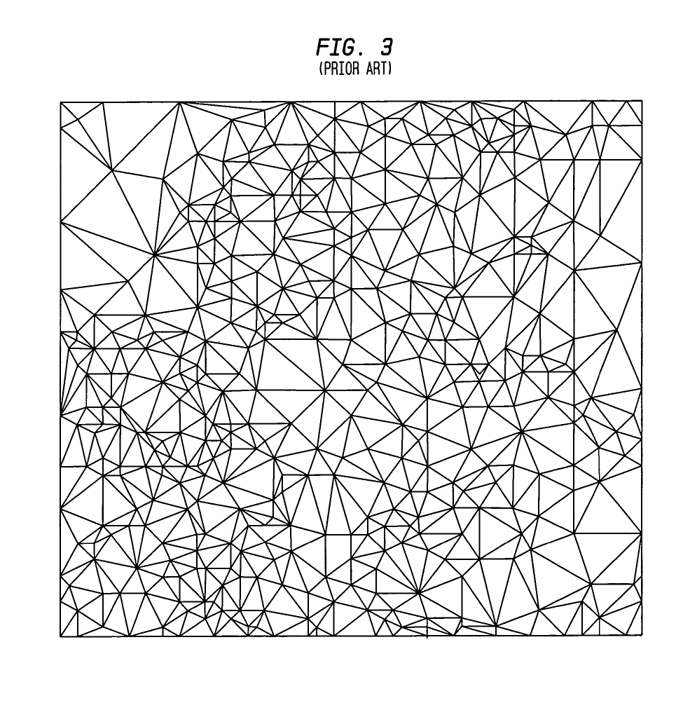

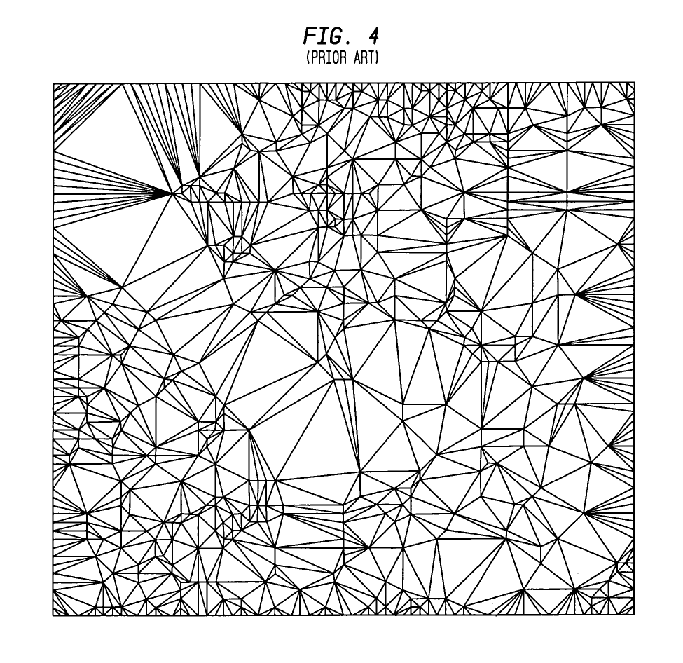

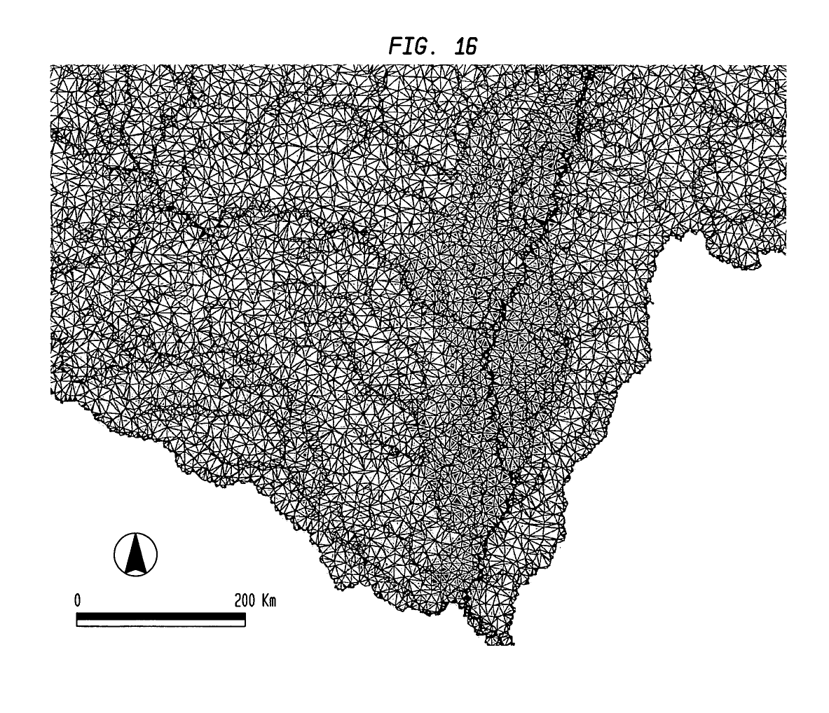

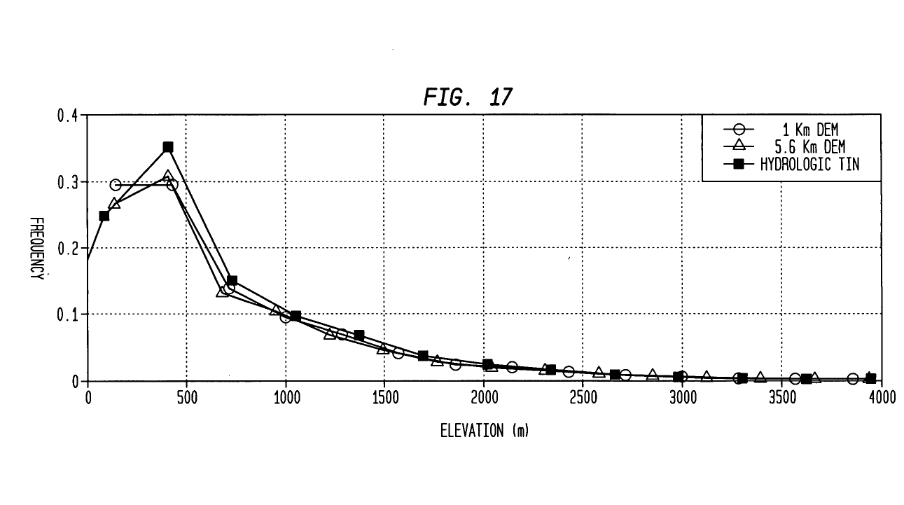

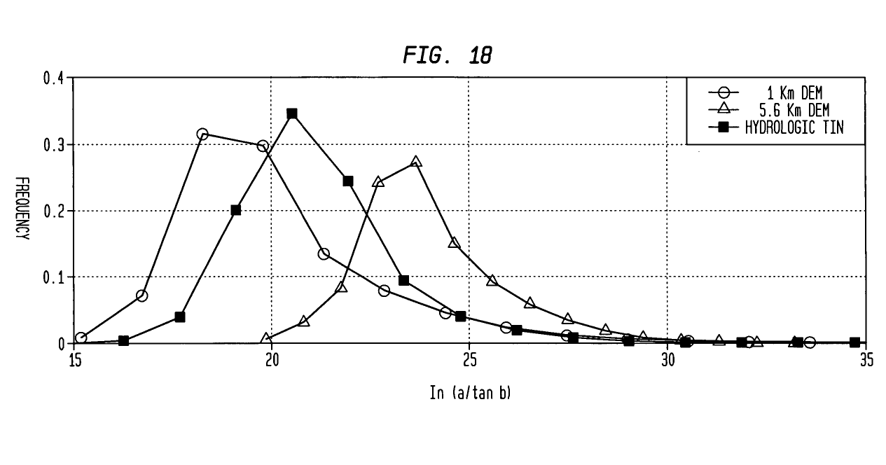

FIG. 16 shows a portion of another hydrologically constrained TIN generated according to the present invention. The hydrologic similarity TIN terrain model of FIG. 16 is of region 102 of the DEM shown in FIG. 1 of the continental-scale Mississippi River basin. The TIN in FIG. 16 contains only 101,756 nodes, corresponding to a data reduction factor of 0.03; that is, the number of nodes making up the TIN is only 3% of the number of grid cells in the original DEM shown in FIG. 1. FIG. 17 compares the elevation PDF of the original 1 km resolution DEM shown in FIG. 1, the TIN of FIG. 16, and a 5.6 kin resolution aggregate DEM corresponding to the same data reduction factor. FIG. 17 compares the topographic model index PDF (in this case the frequency distribution of the topographic function ln(αᵢ/tan βᵢ)) of the same three models. As can be seen, while the aggregate DEM manages to preserve the elevation PDF of the original data, much of the information which determines the hydrologic response of the model is lost. In contrast, the TIN of FIG. 16 preserves both the elevation and topographic PDF while using the same amount of data.

Having described the various aspects and embodiments of the present invention, various modifications and alterations will be readily apparent to those skilled in the art as discussed above, and are intended to fall within the spirit and scope of this invention. In view of the foregoing discussion, it will be obvious to those skilled in the art that the invention is applicable to many areas outside of hydrology or geomorphology. For example, the invention may be used to generate efficient models of deformation of a solid using indices of force distributions. In another example, indices of flow distributions may be used in a pipe or channel or airfoil to model fluid dynamics in the structure. These examples are by no means exhaustive or limiting, it being understood that finite element mesh modeling is applicable to innumerable domains. Accordingly, the invention is limited only as required by the appended claims and equivalents thereto.

What is claimed is:

1. A computer-implemented method of generating a model-specific, computationally efficient representation of a data set comprising an array of original data points, the method comprising:
a) mapping the data set with an index function to create mapped data points;
b) grouping the mapped data points into groups based on a value of the index function for each of the mapped data points;
c) using a selection function, selecting, for each group, mapped points for inclusion in a final representation; and
d) generating a final representation of the data set using, for each mapped point in each group which is selected for inclusion, a corresponding original data point.

2. The method of claim 1, wherein the selection function selects a number of points from each group in correspondence to an average value of the value of the index function for each of the mapped data points.

3. The method of claim 2, wherein the selection function selects a number of points from each group in proportion to an average value of the value of the index function for each of the mapped data points.

4. A computer-implemented method of generating a finite-element mesh incorporating model-specific response to produce variable resolution in the mesh, the method comprising:
a) assigning an index value to each of a group of original elements based on an index function providing a heuristic measure of impact on a model to produce an indexed element for each original element;
b) grouping the indexed elements into at least two groups based on the index value of each element;
c) selecting a subset of indexed elements from each of the groups based on a selection function;
d) creating a finite-element mesh for each of the groups using the corresponding original elements of each of the subset of indexed elements selected by the selection function; and
e) combining the finite-element mesh from each of the groups into a final finite-element mesh.

5. The method of claim 4, wherein the finite-element mesh is a triangular irregular network.

6. The method of claim 4, wherein the index function is a physically-based function based on the original data points.

7. The method of claim 6, wherein the index function is the natural logarithm of an amount of drainage associated with an original element divided by the slope associated with that element.

8. The method of claim 6, wherein the index function is erosion index function.

9. The method of claim 6, wherein the index function is a landslide index function.

10. The method of claim 4, wherein the selection function is a function of the index value of each indexed element.

11. A computer-implemented method of processing an original data set using variable resolution filters, the method comprising:
a) using a ranking function, generating a ranked data set from the original data set;
b) binning a plurality of ranked data points from the ranked data set into at least one bin based on a ranking value of each of the ranked data points;
c) selecting a group of ranked points from each at least one bin according to a selection function based on a rank value of each of the ranked points;
d) creating a data structure for each at least one bin by selecting, for each ranked point from the group of ranked points selected from that bin, a corresponding point from the original data set; and
e) incorporating the data structure from each at least one bin into a final data structure.

12. A computer-implemented method for generating a physically constrained finite-element terrain representation, the method comprising:
a) measuring a set of terrain characteristics for a group of points inside a land area using available digital elevation data;
b) storing the set of terrain characteristics for the group of points in a computer readable medium;
c) using an index function which is a function of the set of terrain characteristics, assigning to each point of the group of points an index value;
d) binning the points into at least two bins based on the index value of each point;
e) using a selection function, selecting a set of points from each of at least two of the bins;
f) generating a finite-element mesh using each selected set of points; and
g) storing the finite-element mesh in a computer memory.

13. The method of claim 12, wherein the available digital elevation data is satellite imaging data.

14. The method of claim 12, wherein the available digital elevation data is airborne imaging data

15. The method of claim 12, wherein the available digital elevation data is data from ground measurements.
